(19) United States
(12) Patent Application Publication
(10) Pub. No.: US 2010/0292916 A1
(43) Pub. Date: Nov. 18, 2010

(54) Navigation System For a Motor Vehicle

(75) Inventors: Maja Kurciska, Sherman Oaks, CA (US); Kenichi Mineta, Rancho Palos Verdes, CA (US)

Correspondence Address: PLUMSEA LAW GROUP, LLC, 10411 MOTOR CITY DRIVE, SUITE 320, BETHESDA, MD, 20817, US

(73) Assignee: Honda Motor Co., Ltd., Tokyo (JP)

(21) Appl. No.: 12/465,308

(22) Filed: May 13, 2009

(51) Int. Cl. G01C 21/36

(52) U.S. Cl. 701/201

(57) ABSTRACT

A navigation system displays multiple alternative routes, some of which use a carpool lane. The calculation of multiple alternative routes allows the user the choice to select a route with a desired number of passengers after the routes and comparative times to travel those routes has been calculated.

### BACKGROUND

The present disclosure relates to a navigation system. In particular, it relates to a navigation system that allows a user to select between routes with carpool lanes and routes without carpool lanes.

Navigation systems are well known in the industry. Navigation systems typically calculate a route from the location of the system to a desired location input by a user. Often, there is a single route that is plausible, and the navigation system directs the user via that path.

In many areas of the country, carpool lanes form an integral part of the transportation system. In the Los Angeles area, for example, almost every major interstate route includes at least one carpool lane (often called an HOV or High Occupancy Vehicle lane). In the Washington, DC metro area, there are entire stretches of interstates that become HOV lanes at certain times of the day. In addition, in Washington, DC and Houston, the HOV lanes are accessible only at certain times of the day and are shared, such that they are open to traffic in one direction during certain hours and to traffic in another direction during other hours. In some cases, however, the use of the HOV lanes may be undesirable. For example, in Houston and Washington, DC, the HOV lanes are separated from other lanes of traffic. Accordingly, if an accident occurs in an HOV lane, it may be impossible to bypass the accident and the HOV lane may be much slower. It is desirable to calculate alternate travel times for a user considering various routes that do and do not use the HOV lanes.

In many of these metropolitan areas, there are parking areas known as “ride sharing lots.” If a user wishes, he may pick up one or more riders at the ride sharing lot in order to permit the use of the carpool lanes. This is convenient for both the driver and the rider, both of whom can then arrive in a downtown area as quickly as possible.

However, a difficulty exists with prior art navigation systems. In prior art systems, the user must either input the number of passengers into the system or the vehicle will sense the number of passengers in the car before making the calculation. There is a need in the art for a system and method that addresses the shortcomings of the prior art discussed above.

### SUMMARY

The invention discloses a navigation system. The invention can be used in connection with a motor vehicle. The term “motor vehicle” as used throughout the specification and claims refers to any moving vehicle that is capable of carrying one or more human occupants and is powered by any form of energy. The term motor vehicle includes, but is not limited to: cars, trucks, vans, minivans, SUVs, motorcycles, scooters, boats, personal watercraft, and aircraft.

In some cases, the motor vehicle includes one or more engines. The term “engine” as used throughout the specification and claims refers to any device or machine that is capable of converting energy. In some cases, potential energy is converted into kinetic energy. For example, energy conversion can include a situation where the chemical potential energy of a fuel or fuel cell is converted into rotational kinetic energy or where electrical potential energy is converted into rotational kinetic energy. Engines can also include provisions for converting kinetic energy into potential energy. For example, some engines include regenerative braking systems where kinetic energy from a drivetrain is converted into potential energy. Engines can also include devices that convert solar or nuclear energy into another form of energy. Some examples of engines include, but are not limited to: internal combustion engines, electric motors, solar energy converters, turbines, nuclear power plants, and hybrid systems that combine two or more different types of energy conversion processes.

In one aspect, the invention provides a method for operating a navigation system, comprising: retrieving a current location; receiving an end point from a user; submitting a route request including the current location and the end point; receiving a first route associated with a carpool lane and a first travel time associated with the first route; receiving a second route excluding all carpool lanes and a second travel time associated with the second route; displaying the first route and the first travel time; displaying the second route and the second travel time; and where the first route is displayed substantially simultaneously with the second route.

In another aspect, the invention provides a method of determining routes for a navigation system, comprising: receiving a route request from an onboard unit of a motor vehicle, the route request including a current location, an end point, and a departure time; retrieving traffic information associated with the departure time; calculating a first route between the current location and the end point using the traffic information, the first route including at least one carpool lane; calculating a second route between the current location and the end point using the traffic information, the second route being a route excluding any carpool lanes; submitting the first route and a first travel time for the first route to the onboard unit; submitting the second route and a second travel time for the second route to the onboard unit; and wherein the first route and the second route are submitted substantially simultaneously.

In another aspect, the invention provides a method of determining routes for a navigation system, comprising: receiving a route request from an onboard unit of a motor vehicle, the route request including a current location, an end point, and a departure time; retrieving traffic information associated with the departure time; calculating a first route between the current location and the end point using the traffic information, the first route including at least one carpool lane; determining the number of passengers required to travel on the first route; calculating a second route between the current location and the end point using the traffic information where the number of passengers required to travel on the second route is different than the number of passengers required to travel on the first route; submitting the first route and a first travel time for the first route to the onboard unit; submitting the second route and a second travel time for the second route to the onboard unit; and wherein the first route and the second route are submitted substantially simultaneously.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic view of an embodiment of a navigation system associated with a motor vehicle;

FIG. 2 is an embodiment of a process for operating a navigation system;

FIG. 3 is an embodiment of a detailed process for operating a navigation system, including steps performed by an on-board unit and steps performed by a remote server;

FIG. 4 is a schematic view of an embodiment of a navigation interface;

FIG. 5 is a schematic view of an embodiment of a navigation interface;

FIG. 6 is a schematic view of an embodiment of a method of determining real-time traffic information;

FIG. 7 is a schematic view of an embodiment of a method of determining real-time traffic information;

FIG. 8 is an embodiment of a process for calculating routes for a navigation system; and

FIG. 9 is an embodiment of a process for calculating routes for a navigation system.

### DETAILED DESCRIPTION

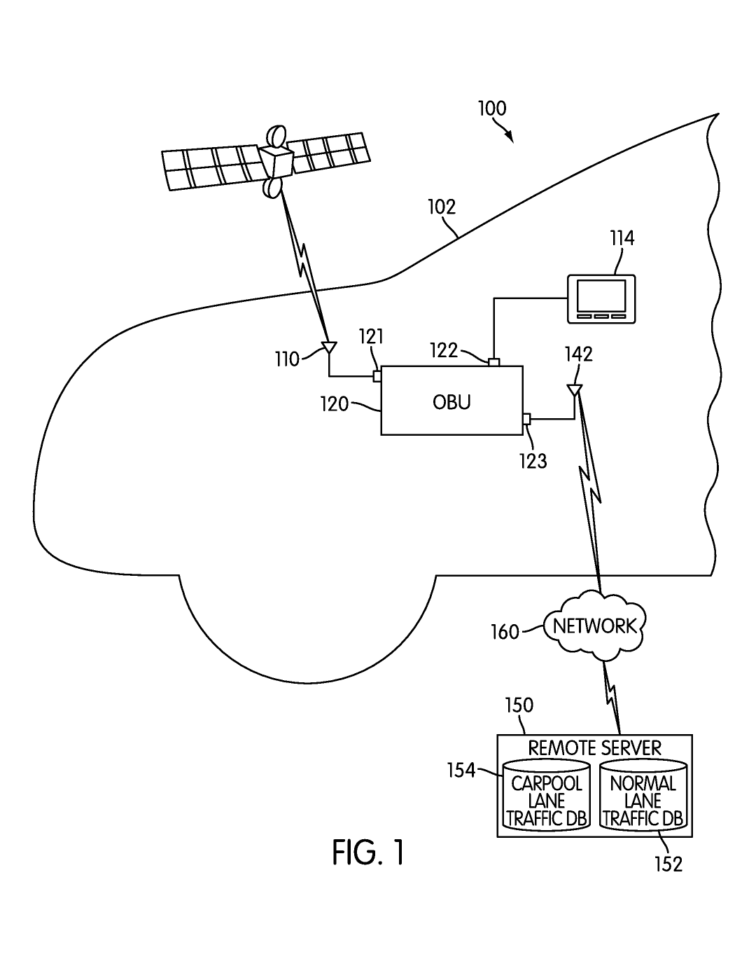

FIG. 1 is a schematic view of an embodiment of navigation system 100 that is configured to be used with motor vehicle 102. For purposes of clarity, only some components of a motor vehicle that may be relevant to navigation system 100 are illustrated. Furthermore, in other embodiments, additional components can be added or removed.

Navigation system 100 can be any system capable of providing navigational information to a user. The term “navigation information” refers to any information that can be used to assist in determining a location or providing directions to a location. Some examples of navigation information include street addresses, street names, street or address numbers, apartment or suite numbers, intersection information, points of interest, parks, any political or geographical subdivision including town, township, province, prefecture, city, state, district, ZIP or postal code, and country. Navigation information can also include commercial information including business and restaurant names, commercial districts, shopping centers, and parking facilities. Navigation information can also include geographical information, including information obtained from any Global Navigational Satellite System (GNSS), including Global Positioning System or Satellite (GPS), Glonass (Russian) and/or Galileo (European). The term “GPS” is used to denote any global navigational satellite system. Navigation information can include one item of information, as well as a combination of several items of information.

Generally, any navigation system known in the art can be used. One example of a navigation system is disclosed in U.S. Patent Application Publication Number 2005/0261827, to Furukawa, and filed on May 19, 2004, the entirety of which is hereby disclosed by reference. Another example of a navigation system is disclosed in U.S. Pat. No. 5,842,146, to Shishido, and filed on May 10, 1996, the entirety of which is hereby disclosed by reference.

Navigation system 100 can include provisions for receiving GPS information. In some cases, navigation system 100 can include GPS receiver 110. For purposes of clarity, GPS receiver 110 is illustrated in the form of a GPS antenna in the current embodiment. However, it will be understood that GPS receiver 110 can be associated with both an antenna and a separate receiving device in some embodiments. In an exemplary embodiment, GPS receiver 110 can be used for gathering a current location for motor vehicle 102. With this arrangement, navigation system 100 may be configured to automatically determine a beginning point for a particular route as well as for tracking the position of motor vehicle 102 along the route.

Navigation system 100 can include provisions for communicating with a driver. In some embodiments, navigation system 100 can include navigation interface 114. In some cases, navigation interface 114 can include provisions for transmitting information to a driver and/or passenger. For example, navigation interface 114 can include a display screen that displays maps including vehicle location and route information. In other cases, navigation interface 114 can include provisions for receiving information from a driver and/or passenger. For example, navigation interface 114 can include buttons that allow a driver to input destinations for determining routes. In some cases, the buttons may be push-type buttons disposed adjacent to a display screen. In other cases, the display screen can be a touch-screen display capable of receiving user input. In an exemplary embodiment, navigation interface 114 can include provisions for transmitting and receiving information from a driver and/or passenger.

Motor vehicle 102 may include provisions for communicating with, and in some cases controlling, the various components associated with navigation system 100. In some embodiments, navigation system 100 may be associated with a computer or similar device. In the current embodiment, navigation system 100 may include onboard unit 120, hereby referred to as OBU 120. In one embodiment, OBU 120 may be configured to communicate with, and/or control, various components of navigation system 100. In addition, in some embodiments, OBU 120 may be configured to control additional components of a motor vehicle that are not shown.

OBU 120 may include a number of ports that facilitate the input and output of information and power. The term “port” as used throughout this detailed description and in the claims refers to any interface or shared boundary between two conductors. In some cases, ports can facilitate the insertion and removal of conductors. Examples of these types of ports include mechanical connectors. In other cases, ports are interfaces that generally do not provide easy insertion or removal. Examples of these types of ports include soldering or electron traces on circuit boards.

All of the following ports and provisions associated with OBU 120 are optional. Some embodiments may include a given port or provision, while others may exclude it. The following description discloses many of the possible ports and provisions that can be used, however, it should be kept in mind that not every port or provision must be used or included in a given embodiment.

In some embodiments, OBU 120 can include first port 121 for communicating with GPS receiver 110. In particular, OBU 120 may be configured to receive GPS information from GPS receiver 110. Also, OBU 120 can include second port 122 for communicating with navigation interface 114. In particular, OBU 120 can be configured to transmit information to navigation interface 114, as well as to receive information from navigation interface 114.

In some embodiments, a navigation system can be associated with remote server 150. The term “remote server” as used throughout this detailed description and in the claims refers to any computing resource that is disposed outside of motor vehicle 102 that is capable of providing resources to motor vehicle 102. In some cases, remote server 150 may be a collection of networked computers or computer servers. Remote server 150 may be used to receive, process and/or store information of any kind. In one embodiment, remote server 150 may be configured to collect information related to traffic on roadways, process the information and store the information for later use. In addition, remote server 150 may be configured to calculate routes for navigation system 100.

A remote server can be provided with various provisions for storing information. In embodiments where a remote server may be used to calculate routes for a navigation system, the remote server can include one or more databases for storing traffic information. Furthermore, in embodiments where routes include both carpool lanes and normal lanes, or non-carpool lanes, a remote server may include separate databases for storing traffic information associated with each type of lane. The term “carpool lane” as used throughout this detailed description and in the claims refers to any lane associated with an occupancy requirement of two or more. In other words, any lane that requires a motor vehicle to have two or more occupants to be used. In some areas, carpool lanes are referred to as high occupancy vehicle lanes, or HOV lanes. In addition, it will be understood that in some cases, a lane may have an occupancy requirement of two or more during some times of day, such as rush hour, and may not have an occupancy requirement during other times of day.

In this embodiment, remote server 150 may be provided with normal lane traffic database 152. In addition, remote server 150 may be provided with carpool lane traffic database 154. With this arrangement, traffic information related to normal lanes may be stored within normal lane traffic database 152 and traffic information related to carpool lanes may be stored within carpool lane traffic database 154. Furthermore, when calculating travel time over carpool lanes, remote server 150 may access carpool lane traffic database 154. Likewise, when calculating travel time over normal lanes, remote server may access normal lane traffic database 152.

A navigation system can include provisions for communicating with a remote server. In one embodiment, navigation system 100 may communicate with remote server 150 using network 160. Generally, network 160 may be any type of network. In some cases, network 160 may be a vehicle communication network that uses motor vehicles for at least some nodes of the network. In addition, a vehicle communication network may include roadside units as nodes. Vehicle communication networks may be used for exchanging various types of information between motor vehicles and/or roadside units. An example of such a vehicular network is a dedicated short range communication (DSRC) network. In some cases, DSRC networks may be configured to operate in the 5.9 GHz band with bandwidth of approximately 75 MHz. Furthermore, DSRC networks may have a range of approximately 1000 m. In other embodiments, navigation system 100 can be configured to communicate with remote server 150 using any other type of wireless network, including, but not limited to: WiFi networks, cell phone networks, as well as any other type of network. Furthermore, network 160 may be associated with any type of network standard including, but not limited to: CDMA, TDMA, GSM, AMPS, PCS, analog and/or W-CDMA.

In some embodiments, OBU 120 may include third port 123 that is configured to communicate with a network antenna. In an exemplary embodiment, third port 123 may be associated with network antenna 142 that is configured to exchange information with remote server 150 using network 160.

Navigation system 100 can include provisions for communicating with one or more components of a motor vehicle that are not associated directly with navigation system 100. In some cases, OBU 120 may include additional ports for communicating directly with one or more additional devices of a motor vehicle, including various sensors or systems of the motor vehicle.

A navigation system can include provisions for calculating and displaying at least two routes to a user. For example, in situations where some routes include highways with carpool lanes, it may be useful to determine a route including a carpool lane and a route not including a carpool lane. Furthermore, both routes may be displayed for a user so the user can select the preferred route.

In some embodiments, a navigation system may be configured to calculate, and display, a first route that includes a carpool lane and a second route that excludes any carpool lanes. In an exemplary embodiment, the first route may be the fastest route that includes at least one carpool lane, while the second route may be the fastest route that does not include any carpool lanes. In other embodiments, however, the first route and the second route may be constrained by other factors as well as travel time. For example, in another embodiment a user may request only routes that do not include toll roads. In this case, the first route may be determined by calculating the fastest route that includes at least one carpool lane and that additionally excludes any toll roads. Likewise, the second route may be determined by calculating the fastest route that excludes carpool lanes and that also excludes toll roads.

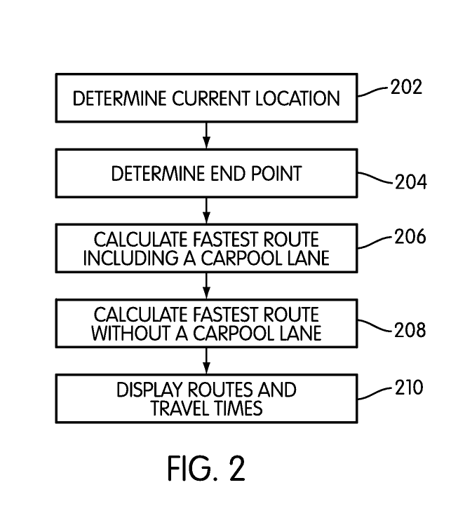

FIG. 2 illustrates an embodiment of a process for operating navigation system 100. In this embodiment, some of the following steps may be performed by OBU 120, while other steps may be performed by remote server 150. In some embodiments, these steps may be performed by additional systems or devices associated with motor vehicle 102 and/or navigation system 100. In addition, it will be understood that in other embodiments one or more of the following steps may be optional.

During step 202, the navigation system may determine a current location. In particular, the navigation system may receive information from a GPS receiver to determine the current location of the motor vehicle. This current location may be used as the start point for a route. Next, during step 204, the system may determine an end point. In some cases, the end point may be received from a user. For example, the user can input a specific address as the end point. The user could also use a search function to select from a set of predefined points, such as by searching for a gas station or selecting from a list of addresses that may have been previously input by the user. Other options would be for a user to select a point on a map graphically or through a voice activated system. Any conventional technology can be used to make the selection. In addition, steps 202 and 204 need not take place in a particular order. The two steps can be done in either sequence or simultaneously.

Following step 204, the navigation system may proceed to step 206. During step 206, the navigation system calculates the fastest route between the start point and the end point that uses a carpool lane. Next, during step 208, the navigation system calculates the fastest route without a carpool lane. In some cases, step 206 and/or step 208 can be performed by the OBU. In other cases, step 206 and/or step 208 can be accomplished by a remote server in communication with the OBU. Furthermore, step 206 and step 208 can be accomplished using any method known in the art for determining optimal routes between a start point and an end point.

Following step 208, the navigation system may proceed to step 210. During step 210, the navigation system may display the two routes calculated during steps 206 and 208. In addition, during step 210, the navigation system may display the travel times associated with each route. At this point, a user may select one of the routes according to the travel time.

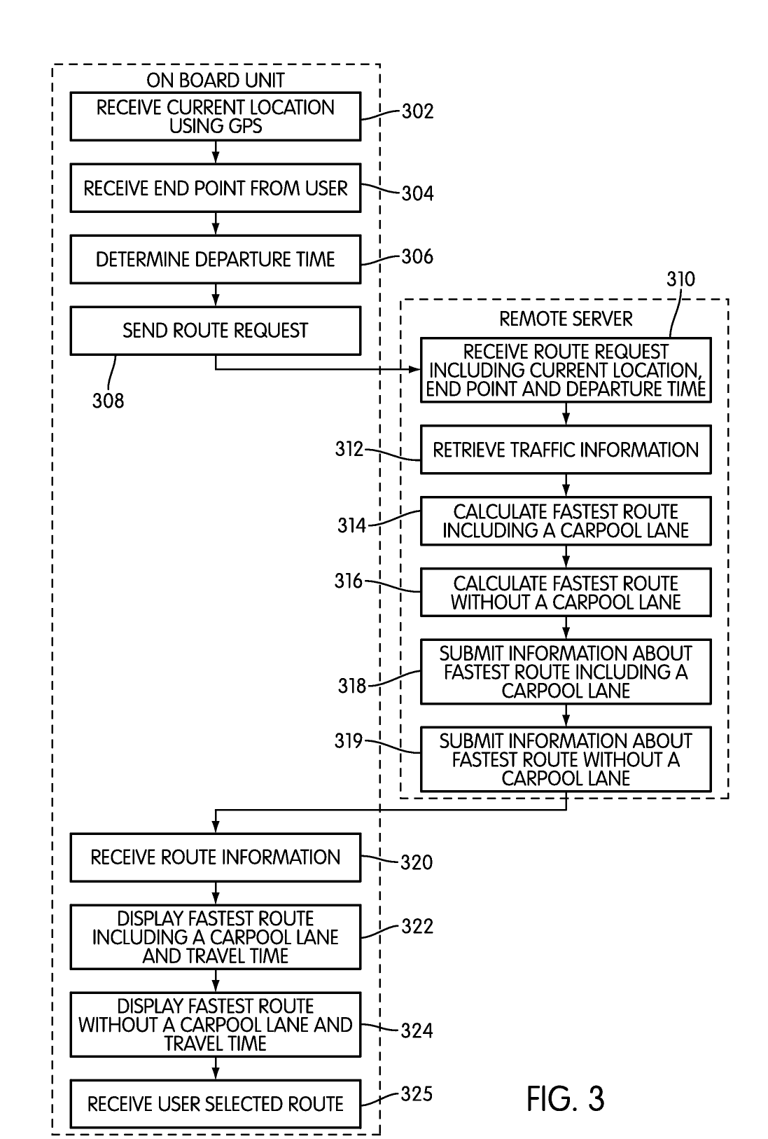

FIG. 3 illustrates an embodiment of a detailed process for operating navigation system 100. In this embodiment, some of the following steps may be performed by OBU 120, while other steps may be performed by remote server 150. In some embodiments, these steps may be performed by additional systems or devices associated with motor vehicle 102 and/or navigation system 100. In addition, it will be understood that in other embodiments one or more of the following steps may be optional.

During step 302, the navigation system may receive the current location of the motor vehicle using information received from a GPS receiver. Next, during step 304, the navigation system may receive an end point from a user, as discussed above. Following step 304, the navigation system may determine a departure time during step 306. In particular, in some cases, a departure time may be associated with the time at which the user submits an end point and requests a route. Following step 306, the navigation system may proceed to step 308. During step 308, the navigation system submits a route request. In particular, the route request is a request for one or more routes associated with the current location, end point and departure time determined during the previous steps.

As previously discussed, the navigation system can include provisions for sending information to a remote server using one or more networks. In this case, a route request may be transmitted over a network and received at a remote server. During step 310, the route request, including current location, end point and departure time, are received at the remote server.

Following step 310, during step 312, the remote server may retrieve traffic information. Generally, the traffic information can be any type of traffic information gathered using any method known in the art. In some cases, the traffic information can be determined by monitoring the travel times of various users that are also in communication with the remote server. In particular, in situations where a remote server is in communication with multiple vehicles in a vehicle communication network, each associated with a navigation system, the travel times of the users on various roadways can be collected and stored as traffic information. In other cases, the traffic information can be determined by sending out dedicated vehicles on various roadways to determine real-time traffic information. In still other cases, historical traffic data associated with average traffic patterns over particular roadways at various times and/or dates can be used. With this arrangement, travel times for various routes can be calculated more accurately to include variations in travel time due to various traffic conditions.

Following step 312, the remote server may proceed to step 314. During step 314, the remote server calculates the fastest route between the current location and the end point that uses a carpool lane. Next, during step 316, the remote server calculates the fastest route between the current location and the end point without a carpool lane. At this point, the remote server may proceed to step 318.

During step 318, the remote server may submit information related to the fastest route including a carpool lane. In some cases, the remote server may submit route details including a travel time. In addition, in some cases, the remote server can submit an occupancy requirement. Following this, during step 319, the remote server may submit information related to the fastest route without a carpool lane. In some cases, the remote server may submit route details including a travel time. It will be understood that step 318 and step 319 can occur in any order. In an exemplary embodiment, step 318 and step 319 can occur substantially simultaneously.

Following step 319, during step 320, the navigation system receives the route information from the remote server. In particular, the navigation system receives information about the fastest route including a carpool lane and information about the fastest route without a carpool lane. Next, during step 322, the navigation system may display the fastest route including a carpool lane and the corresponding travel time. In addition, and in some cases simultaneously, the navigation system may display the fastest route without a carpool lane and the corresponding travel time during step 324. It will be understood that step 322 and step 324 can occur in any order. In an exemplary embodiment, step 322 and 324 can occur substantially simultaneously.

Once the user evaluates the information, the user can select an appropriate route to take. In some cases, following step 324, the OBU can receive a user selected route that is either the first route or the second route during step 325. The navigation system may then provide directions or other navigational information for the user selected route. At this point, the user can also determine whether he or she should stop at a ride sharing location to pick up one or more passengers to travel with in order to use the carpool lanes. In some cases, a user may determine that he or she wants to use a carpool lane even if the calculated time is higher than a non-carpool lane in order to altruistically save fossil fuels or to have company. Providing the information for the user to consider allows this choice.

It will be understood that in some cases, a navigation system may also display the number of occupants required to travel along any route that includes a carpool lane. Since some carpool lanes require different numbers of occupants, the navigation system may display the number of occupants along each route, in addition to displaying travel times, so the user can determine how many occupants are necessary to travel in the carpool lane. With this arrangement, if the non-carpool route is calculated to be significantly longer than the carpool route, a user can elect to pick up one or more passengers from a ride share lot and take the carpool route.

The system may also consider the present location of the user. Carpool lanes are common in large cities, but are less common in other cities with less traffic congestion. The system can be equipped to determine whether the use of an HOV lane is meaningful or reasonable in a particular situation before displaying it as an option. For example, for a user in Kansas City, Kans. traveling between locations in Kansas City, the nearest HOV lane may be in Minneapolis, Minn., which is not a meaningful route for the user. Accordingly, the system can be designed to allow the user to make a selection to determine whether the alternative route selection should be permitted. Alternatively, the system can determine the distance between the nearest HOV lane and the fastest route and then determine if alternative routes using carpool lanes should be rejected.

In addition, the system can evaluate data present inside the vehicle. For example, a sensor system may be incorporated into the vehicle to detect, for example, the position of occupants for determining the actuation of an SRS system in the event of an accident. Such a system can be incorporated as a module in the navigation system. If a user chooses a route that requires more occupants than are present in the vehicle, the system can produce an alert notifying the driver of that fact so that the driver can select a different route or pick up the requisite number of occupants.

Although the embodiment discussed above includes provisions for calculating travel routes using a remote server, in other embodiments, a navigation system can be configured to calculate travel routes using one or more devices onboard the motor vehicle. For example, in some cases, an OBU can be configured to receive traffic information from a vehicle communication network. Using this traffic information, the OBU may calculate travel routes including carpool lanes and travel routes not including carpool lanes as discussed above.

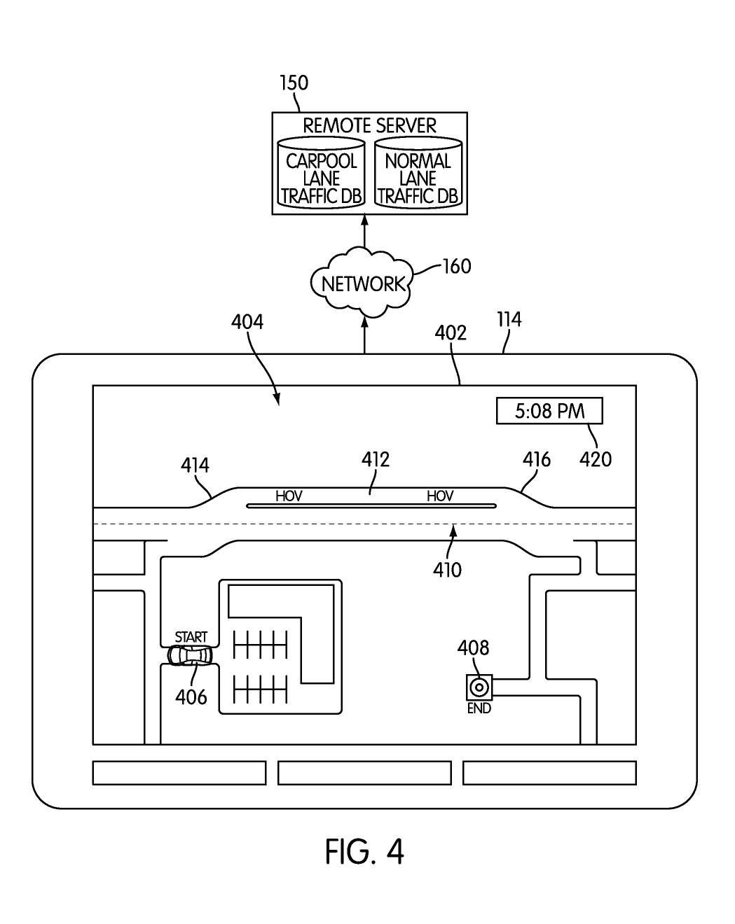

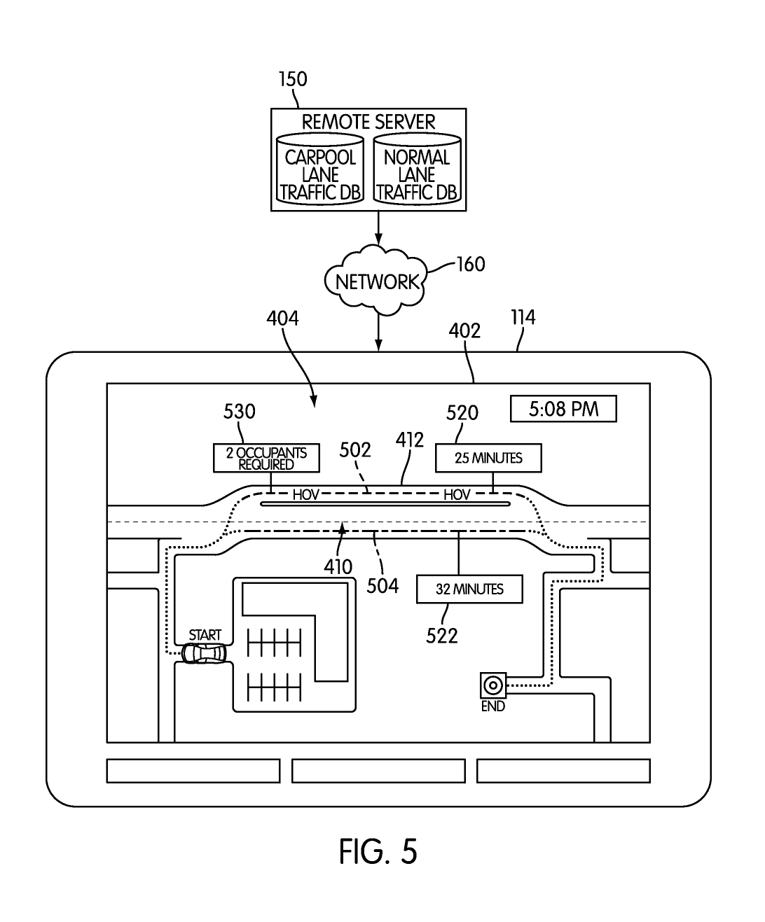

FIGS. 4 and 5 illustrate schematic views of navigation interface 114 of navigation system 100. Referring to FIG. 4, navigation interface 114 includes display screen 402. In this case, display screen 402 is configured to display map 404. Furthermore, display screen 402 is configured to display motor vehicle indicia 406, which indicates the current location of a motor vehicle within map 404. Typically, the current location is used as the start point for determining a route. Likewise, display screen 402 indicates end point indicia 408 that indicates the location of the intended end point for a user. For example, in one embodiment, a user may be leaving work and planning to drive home.

Map 404 may include a plurality of roads, including highway 410. In this case, highway 410 is a highway including carpool lane 412. Furthermore, carpool lane 412 is separated from the remaining lanes of highway 410. In particular, carpool lane 412 may be accessed using first exit 414. Likewise, a motor vehicle may exit carpool lane 412 using second exit 416. This arrangement requires a driver that enters carpool lane at first exit 414 to stay in carpool lane 412 until second exit 416. Therefore, a user considering traveling in carpool lane 412 may desire to know that taking carpool lane 412 will result in a shorter travel time over traveling in the other lanes of highway 410.

In this embodiment, upon receiving an end point entered by a user at navigation interface 114, the navigation system may send a request for a travel route to remote server 150. In some cases, the route request may include the current location, the end point, and the departure time. In this embodiment, departure time 420 is associated with the current time. In order to submit a route request, navigation system 100 may communicate with remote server 150 using network 160. Upon receiving a request for a route, the remote server may calculate a fastest travel route using a carpool lane and a fastest travel route without a carpool lane, as discussed previously.

Referring to FIG. 5, remote server 150 may submit one or more routes to navigation system 100 using network 160. In particular, remote server 150 may send navigation system 100 a first route, which is the fastest route including a carpool lane and a second route, which is the fastest route that does not include a carpool lane. In this embodiment, first route 502 and second route 504 are displayed on display screen 402. In this embodiment, first route 502 and second route 504 overlap near the beginning point and end point of each route. However, first route 502 includes a first route portion that is associated with carpool lane 412 of highway 410. In contrast, second route 504 includes a second route portion that is associated with the non-carpool portion of highway 410.

In addition, remote server 150 may send navigation system 100 travel times associated with first route 502 and second route 504. In particular, first travel time indicator 520 and second travel time indicator 522 display the travel times associated with first route 502 and second route 504, respectively. In this case, first travel time indicator 520 displays a travel time of 25 minutes, while second travel time indicator 522 displays a travel time of 32 minutes.

In addition, in some embodiments, remote server 150 may send occupant requirements for routes associated with carpool lanes. In this embodiment, occupant indicator 530 is associated with first route 502. Occupant indicator 530 informs the user that 2 occupants are required to travel in the carpool lane associated with first route 502. In other embodiments including routes with multiple carpool lanes that require different numbers of occupants, the occupant indicator can display the minimum number of occupants required to travel the entire route including all carpool lanes on the route.

With this arrangement, a user can quickly see the fastest route including a carpool lane and the fastest route without a carpool lane, along with the corresponding travel times. In addition, the occupant indicator allows a user to quickly see how many passengers would be needed to travel the route associated with a carpool lane. Using this information, the user can select the travel route they prefer according to the travel times and according to the number of occupants required. For example, if a travel route including a carpool lane has a travel time that is only a few minutes less than the non-carpool lane route, then the user may decide to travel the non-carpool lane route rather than taking the extra time necessary to pick up a passenger at a ride sharing lot. On the other hand, if the travel time of the carpool lane route is substantially less than the non-carpool lane travel route, the user may decide to pick up one or more passengers at a ride sharing lot to take advantage of the reduced travel time. Still further, in cases where a motor vehicle already has several occupants, a user can still choose to take a non-carpool lane route when the carpool lane route is associated with a significantly longer travel time.

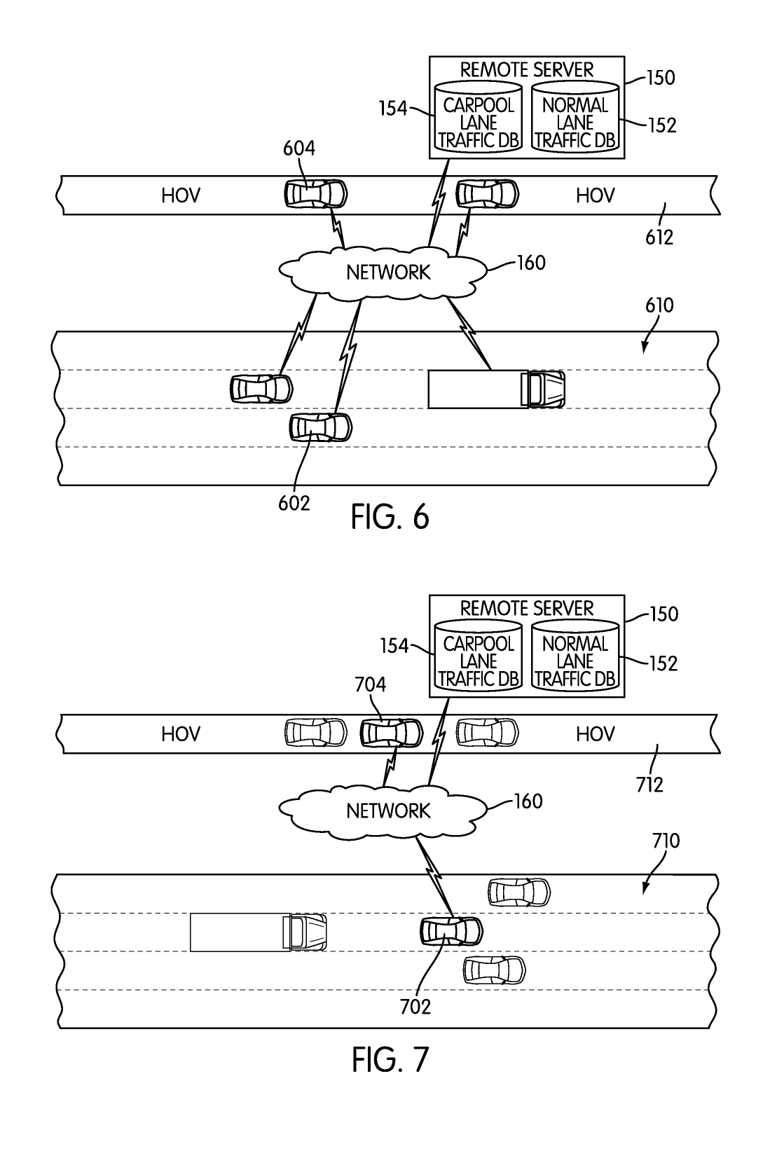

FIGS. 6 and 7 illustrate schematic views of embodiments of methods of retrieving real-time traffic information for a remote server. It should be understood that the two methods illustrated here are only intended to be exemplary, and other embodiments can use any other provisions for gathering traffic information related to one or more roadways.

Referring to FIG. 6, remote server 150 may receive information from a plurality of motor vehicles using network 160. In this embodiment, first set of vehicles 602 may be traveling on highway 610. In particular, first set of vehicles 602 may be traveling in lanes that are non-carpool lanes. In contrast, second set of vehicles 604 may be traveling in carpool lane 612 of highway 610. Furthermore, each vehicle of first set of vehicles 602 and second set of vehicles 604 may include GPS-based navigation systems. As each vehicle travels along highway 610, the travel times of each vehicle along a current route may be sent to remote server 150 and stored as real-time traffic information. By combining information from a plurality of vehicles on a given route, remote server 150 can determine real-time traffic information. For example, remote server 150 can determine routes with heavy congestion by comparing current average traveling times of a plurality of vehicles with known travel times for the route during non-congested conditions.

In this embodiment, using information received from first set of vehicles 602, remote server 150 may determine traffic information for non-carpool lanes of highway 610. In some cases, information received from first set of vehicles 602 may be stored within normal lane traffic database 152. This information can then be used by the server in calculating more accurate travel times for routes using the non-carpool lanes of highway 610. Likewise, using information received from second set of vehicles 604, remote server 150 may determine traffic information for carpool lane 612 of highway 610. In some cases, information received from second set of vehicles 604 may be stored within carpool lane traffic database 154. This information can be used for calculating more accurate traveling times for routes using carpool lane 612.

Referring to FIG. 7, remote server 150 may be configured to receive information from dedicated vehicles. In some embodiments, one or more dedicated vehicles may be sent out to travel various routes in order to determine real-time traffic information. For example, in cities with major highways or “beltways,” several dedicated vehicles can be configured to travel along parts of the highways or beltways to determine real-time traffic conditions. In some cases, the traffic conditions can be calculated using a GPS-based navigation system. In other cases, the operators of the dedicated vehicles may send back reports about the observed traffic patterns. These reports can then be used to estimate parameters to be stored in a traffic database.

In this embodiment, remote server 150 is configured to receive traffic information from first dedicated vehicle 702 and second dedicated vehicle 704. First dedicated vehicle 702 is traveling on highway 710 in a non-carpool lane. In contrast, second dedicated vehicle 704 is traveling in carpool lane 712 of highway 710. Using information from first dedicated vehicle 702, remote server 150 may determine traffic information for non-carpool lanes of highway 710. Likewise, using information received from second dedicated vehicle 704, remote server 150 may determine traffic information for carpool lane 712 of highway 710. This information can be used for calculating more accurate travel times for various routes by incorporating real-time traffic information.

The methods illustrated in FIGS. 6 and 7 for determining traffic information to be stored and used by a remote server are only intended to be illustrative. In other embodiments, any other methods for determining traffic information can be used. For example, in some cases, historical traffic information can be used. Furthermore, the methods discussed above for gathering real-time traffic information can also be stored and used to determine historical traffic information as well. For example, in cases where real-time traffic information may not be known for a particular roadway, previously stored traffic information recorded in the manners illustrated in FIGS. 6 and 7 over some period of time can be used to determine average traffic patterns that depend on the time of day and/or day of the week. These averages provide historical traffic information that can be used in estimating travel routes even when real-time traffic information is not available.

A navigation system can include provisions for determining different routes associated with carpool lanes with different occupancy requirements. In some areas two different highways, or two different portions of the same highway, may have carpool lanes with different occupancy requirements. For example, one highway near a major metropolitan area may have a carpool lane requiring at least two occupants (a driver and a passenger) and a second nearby highway may have a carpool lane requiring at least three occupants. Therefore, it may be useful to calculate one route using the first carpool lane and another route using the second carpool lane to provide the user with more options for selecting a desired route.

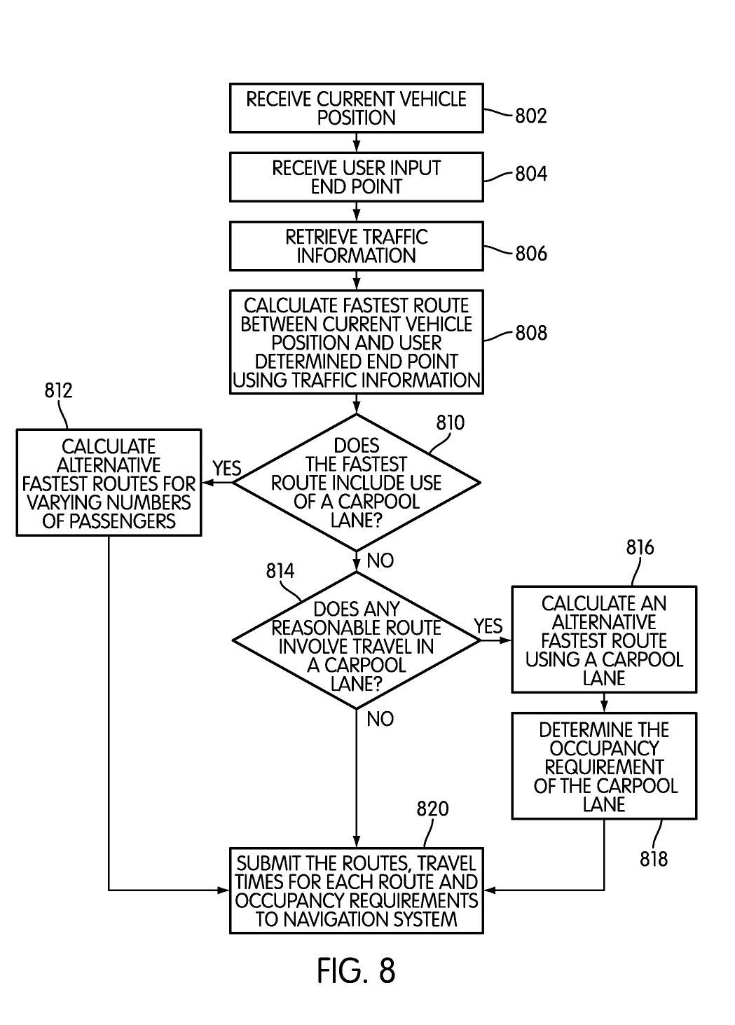

FIG. 8 illustrates an embodiment of a process for calculating multiple routes with carpool lanes, with each route requiring a different number of occupants. In this embodiment, some of the following steps may be performed by OBU 120, while other steps may be performed by remote server 150. In some embodiments, these steps may be performed by additional systems or devices associated with motor vehicle 102 and/or navigation system 100. In addition, it will be understood that in other embodiments one or more of the following steps may be optional. In an exemplary embodiment, the following steps may be performed by remote server 150.

During a first step 802, a remote server may receive a current vehicle position. In some cases, the current vehicle position may be submitted by a navigation system according to GPS information. Next, during step 804, the remote server may receive a user input end point. Following step 804, the remote server can retrieve traffic information during step 806. As previously discussed, the traffic information can be historical traffic data, real-time traffic data, a combination of historical and real-time traffic data or any other type of traffic information.

Once the remote server has determined the current position or start point as noted in step 802, the desired end position in step 804, and retrieved relevant traffic information during step 806, the remote server can then calculate a fastest route between the current position and the end point as shown in step 808. This calculation can be any conventional calculation algorithm or system. Following step 808, the remote server can proceed to step 810. During step 810, the remote server determines if the fastest route determined during step 808 includes the use of a carpool lane. If not, the remote server proceeds to step 814.

During step 814, the remote server determines if any reasonable route between the current location and the end point involves traveling in a carpool lane. Since carpool lanes are less common in some cities with low traffic congestion, the system can be equipped to determine whether the use of an HOV lane is meaningful or reasonable in a particular situation before determining if an alternate route including a carpool lane should be calculated. Accordingly, the system can use any meaningful variable to determine whether it is useful to consider carpool lanes. For example, the system could search for the nearest carpool lane and determine whether the carpool lane is within a designated number of miles from the vehicle start point. Any data could be incorporated into this calculation.

If, during step 814, the remote server determines that there is a reasonable route between the start point and the end point that involves traveling in a carpool lane, then the remote server may proceed to step 816. Otherwise, the remote server proceeds to step 820, which is discuss in detail below. During step 816, the remote server calculates an alternative fastest route that uses at least one carpool lane. Following step 816, the remote server proceeds to step 818, where the remote server determines the number of passengers required to use the carpool lane (the occupancy requirement) associated with the alternative fastest route. At this point, the remote server proceeds to step 820.

During step 820, the remote server may submit each calculated route, including the travel time for each route and the occupancy requirement for each route, to the navigation system. Following this, in some embodiments, each route, including the travel time for each route and the occupancy requirement for each route may be displayed on the navigation interface of the motor vehicle.

If, during step 810, the remote server determines that the fastest route does include the use of a carpool lane, the remote server may proceed to step 812. During step 812, the remote server may calculate one or more alternative fastest routes where each different route is associated with a different occupancy requirement. This step is discussed in detail below. Following step 812, the remote server may proceed to step 820. During step 820, the remote server may submit the various calculated routes, including travel time for each route and occupancy requirement for each route, to the navigation system.

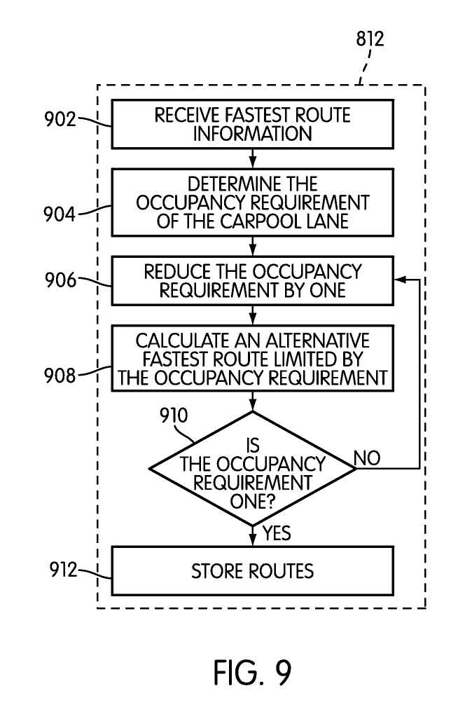

FIG. 9 illustrates an embodiment of a detailed process for calculating alternative fastest routes for varying numbers of passengers. In this embodiment, some of the following steps may be performed by OBU 120, while other steps may be performed by remote server 150. In some embodiments, these steps may be performed by additional systems or devices associated with motor vehicle 102 and/or navigation system 100. In addition, it will be understood that in other embodiments one or more of the following steps may be optional. In an exemplary embodiment, the following steps may be performed by remote server 150.

During step 902, the remote server receives the fastest route information that has been calculated during step 808 of the process illustrated in FIG. 8. Next, during step 904, the remote server may determine the number of passengers necessary to use a carpool lane associated with the fastest route. In cases where the fastest route includes multiple carpool lanes, the occupancy requirement is determined to be the minimum number of occupants required to travel the entirety of the fastest route, including all carpool lanes.

Next, during step 906, the remote server may reduce the occupancy requirement by one. Following this, during step 908, the remote server may calculate an alternative fastest route that is limited by the current occupancy requirement. For example, if the occupancy requirement for the first route is three, then during step 906 the remote server may set the occupancy requirement at two. Furthermore, when calculating an alternative fastest route during step 908, the remote server will only calculate a fastest route in which at least two occupants are required to travel on any carpool lanes associated with the alternative fastest route.

This new reduced occupancy requirement may prevent the use of certain carpool lanes while allowing the use of other carpool lanes. In some geographic areas, there are carpool lanes on different freeways that include different numbers of riders necessary in order to use the lanes. For example, a carpool lane on one freeway may require three occupants to be in the vehicle and a carpool lane on a nearby freeway may require only two occupants to be in the vehicle. Therefore, the alternative route calculated during step 908 may also allow use of a carpool lane.

Following step 908, the remote server may proceed to step 910. During step 910, the remote server may determine if the occupancy requirement is one. If the occupancy requirement is one, the remote server will proceed to step 912 where each calculated route is stored, including associated travel times and occupancy requirements. If, however, the remote server determines that the occupancy requirement is not one during step 910, the remote server may proceed back to step 906. In this manner, step 906, step 908 and step 910 may be repeated until the occupancy requirement is one. In other words, the remote server may calculate an alternative route for each different value of the occupancy requirement between the value of the occupancy requirement associated with the first fastest route and an occupancy requirement of one.

It may be possible that in many cases, there is no difference between two of the routes calculated. For example, if the best route calculated in step 908 requires that there be three passengers in the car, and there are no carpool lanes that require the use of two passengers, the best route for the use of two passengers and the best route that requires only one passenger will be identical. In such a case, the system will display the alternative route and will only list the smallest number of passengers required to use that route. In the example cited, that number would be one.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A method for operating a navigation system, comprising:
retrieving a current location;
receiving an end point from a user;
submitting a route request including the current location and the end point;
receiving a first route associated with a carpool lane and a first travel time associated with the first route;
receiving a second route excluding all carpool lanes and a second travel time associated with the second route;
displaying the first route and the first travel time;
displaying the second route and the second travel time; and
wherein the first route is displayed substantially simultaneously with the second route.

2. The method according to claim 1, wherein the first route is a fastest route between the current location and the end point including a carpool lane.

3. The method according to claim 1, wherein the second route is a fastest route between the current location and the end point that excludes all carpool lanes.

4. The method according to claim 1, wherein the step of receiving the end point is followed by a step of retrieving a departure time.

5. The method according to claim 4, wherein the step of submitting the route request includes submitting the departure time.

6. The method according to claim 1, wherein the step of receiving the first route includes receiving a number of occupants required to travel the first route.

7. The method according to claim 6, wherein the step of displaying the first route includes a step of displaying the number of occupants required to travel the first route.

8. The method according to claim 1, wherein the step of displaying the second route is followed by a step of receiving a user selected route, the user selected route being either the first route or the second route and wherein the navigation system provides directions to the user according to the user selected route.

9. The method according to claim 1, wherein the route request is submitted to a remote server and wherein the remote server is configured to calculate the first route and the second route.

10. A method of determining routes for a navigation system, comprising:
receiving a route request from an onboard unit of a motor vehicle, the route request including a current location, an end point, and a departure time;
retrieving traffic information associated with the departure time;
calculating a first route between the current location and the end point using the traffic information, the first route including at least one carpool lane;
calculating a second route between the current location and the end point using the traffic information, the second route being a route excluding any carpool lanes;
submitting the first route and a first travel time for the first route to the onboard unit;
submitting the second route and a second travel time for the second route to the onboard unit; and
wherein the first route and the second route are submitted substantially simultaneously.

11. The method according to claim 10, wherein the first route is a fastest route between the current location and the end point using at least one carpool lane.

12. The method according to claim 10, wherein the second route is a fastest route between the current location and the end point excluding any carpool lanes.

13. The method according to claim 10, wherein the step of calculating the second route is followed by the steps of:
calculating the number of passengers necessary to allow travel on the first route;
calculating a third route between the current location and the end point where the number of passengers necessary to allow travel on the third route is at least one fewer than the number of passengers necessary to allow travel on the first route and where the number of passengers necessary to allow travel on the third route is greater than one;
submitting the third route and a third travel time to the onboard unit; and
submitting the number of passengers necessary to allow travel on the first route and the number of passengers necessary to allow travel on the third route to the onboard unit.

14. The method according to claim 10, wherein the traffic information is historical traffic data.

15. The method according to claim 10, wherein the traffic information is real-time traffic data.

16. The method according to claim 15, wherein the real-time traffic data is received from at least one motor vehicle traveling on a portion of the first route or the second route.

17. A method of determining routes for a navigation system, comprising:
receiving a route request from an onboard unit of a motor vehicle, the route request including a current location, an end point, and a departure time;
retrieving traffic information associated with the departure time;
calculating a first route between the current location and the end point using the traffic information, the first route including at least one carpool lane;
determining the number of passengers required to travel on the first route;
calculating a second route between the current location and the end point using the traffic information where the number of passengers required to travel on the second route is different than the number of passengers required to travel on the first route;
submitting the first route and a first travel time for the first route to the onboard unit;
submitting the second route and a second travel time for the second route to the onboard unit; and
wherein the first route and the second route are submitted substantially simultaneously.

18. The method according to claim 17, wherein the traffic information includes traffic information retrieved from a carpool lane traffic database.

19. The method according to claim 17, wherein the traffic information includes traffic information retrieved from a normal lane traffic database.

20. The method according to claim 17, wherein the step of submitting the first route includes submitting a first occupancy requirement for the first route and wherein the step of submitting the second route includes submitting a second occupancy requirement for the second route.
